(19) United States
(12) Patent Application Publication
(10) Pub. No.: US 2025/0294315 A1
(43) Pub. Date: Sep. 18, 2025

(54) INFORMATION PROCESSING METHOD, MOBILE BODY, COMMUNICATION DEVICE, AND COMPUTER PROGRAM

(71) Applicant: SONY GROUP CORPORATION, TOKYO (JP)

(72) Inventor: HAJIME TAKANO, TOKYO (JP)

(21) Appl. No.: 18/862,294

(22) PCT Filed: May 1, 2023
(86) PCT No.: PCT/JP2023/017019

§ 371 Date: Nov. 1, 2024

(30) Foreign Application Priority Data
May 11, 2022 (JP) 2022-078477

(51) Int. Cl. H04W 4/02; G08G 5/26; H04B 7/185

(52) U.S. Cl. CPC H04W 4/023; G08G 5/26; H04B 7/18502

(57) ABSTRACT

Provided is an information processing method including a position identification step, a second-machine information reception step, a positional relation identification step, and an antenna control step.

### CROSS REFERENCE TO RELATED APPLICATIONS

This application claims the benefit of Japanese Priority Patent Application JP 2022-078477 filed May 11, 2022, the entire contents of which are incorporated herein by reference.

### TECHNICAL FIELD

The present disclosure relates to an information processing method, a mobile body, a communication device, and a computer program.

### BACKGROUND ART

The use of mobile bodies such as drones remotely controlled by wireless communication is now being seen in various fields. Drones have already been used for various uses such as aerial photography, measurement, disaster relief or transportation and physical distribution, for example. Note that, in a case where simply the word drone is used, this word means an unmanned aerial vehicle.

A drone can be controlled by control commands wirelessly transmitted from a controller operated by an operator. In addition, a drone can also be controlled by control commands wirelessly transmitted from a controller via a router or from a controller via a router and a base station.

A frequency band used for wireless communication with a drone is the 2.4 GHz band, the 5 GHz band or the like, for example. Typically, such frequency bands are specified by a government or the like.

It is expected that the demand for drones will rise increasingly in the coming future. Then, a situation where many drones fly in the air in proximity to each other can be realized. However, in a case where a plurality of drones shares a particular frequency band in such a situation, a problem of radio wave interference can occur.

That is, there can be a situation where a status of wireless communication between a subject-machine drone and a controller or the like is deteriorated due to the influence of radio waves used by a second drone for wireless communication. In this case, there is a fear that operation of the drone is hindered, a video sent from the drone is distorted, and so on, for example.

### CITATION LIST

### Patent Literature

### [PTL 1]

Japanese Patent Application Laid-Open No. 2022-040462

### SUMMARY

### Technical Problem

The present disclosure has been made taking into consideration the matters described above, and provides an information processing method, a mobile body, a communication device, and a computer program that can reduce deterioration of the status of wireless communication between a mobile body and a communication device due to the influence of wireless communication performed by a second mobile body.

### Solution to Problem

An information processing method according to an embodiment of the present disclosure includes a position identification step of identifying a position of a mobile body and/or a position of a communication device that wirelessly communicates with the mobile body, a second-machine information reception step of receiving specific information that is sent from a second mobile body, and is for identifying a presence and/or a position of the second mobile body, a positional relation identification step of identifying a positional relation between the mobile body and the second mobile body and/or a positional relation between the communication device and the second mobile body, on the basis of the position of the mobile body and/or the position of the communication device, and the specific information, and an antenna control step of controlling at least a directionality of a mobile-body-side antenna of the mobile body and/or a directionality of a communication-device-side antenna of the communication device, on the basis of the positional relation between the mobile body and the second mobile body and/or the positional relation between the communication device and the second mobile body.

A mobile body according to another embodiment of the present disclosure includes a wireless communication section that transmits and receives radio waves via an antenna, and an antenna control section that controls at least a directionality of the antenna on the basis of a positional relation between the mobile body and a second mobile body.

A communication device according to yet another embodiment of the present disclosure is a communication device that wirelessly communicates with a mobile body, and includes a wireless communication section that transmits and receives radio waves via an antenna, a position identifying section that identifies a position of a mobile body and/or a position of the communication device, a second-machine information receiving section that receives specific information that is sent from a second mobile body, and is for identifying a presence and/or a position of the second mobile body, a positional relation identifying section that identifies a positional relation between the mobile body and the second mobile body and/or a positional relation between the communication device and the second mobile body, on the basis of the position of the mobile body and/or the position of the communication device, and the specific information, and an antenna control section that controls at least a directionality of the antenna on the basis of the positional relation between the mobile body and the second mobile body and/or the positional relation between the communication device and the second mobile body.

A computer program according to a further embodiment of the present disclosure causes a computer to execute a position identification step of identifying a position of a mobile body and/or a position of a communication device that wirelessly communicates with the mobile body, a second-machine information reception step of receiving specific information that is sent from a second mobile body, and is for identifying a presence and/or a position of the second mobile body, a positional relation identification step of identifying a positional relation between the mobile body and the second mobile body and/or a positional relation between the communication device and the second mobile body, on the basis of the position of the mobile body and/or the position of the communication device, and the specific information, and an antenna control step of controlling at least a directionality of a mobile-body-side antenna of the mobile body and/or a directionality of a communication-device-side antenna of the communication device on the basis of the positional relation between the mobile body and the second mobile body and/or the positional relation between the communication device and the second mobile body.

### BRIEF DESCRIPTION OF DRAWINGS

FIG. 1 is a figure depicting a situation according to a first embodiment where a drone as a mobile body is caused to fly by a controller.

FIG. 2 is a block diagram depicting the configuration of the drone according to the first embodiment.

FIG. 3 is a block diagram depicting the configuration of the controller according to the first embodiment.

FIG. 4 is a figure depicting an example of the configuration of antennas provided on the drone and the controller according to the first embodiment.

FIG. 5 is a flowchart depicting an example of a process performed at the drone according to the first embodiment.

FIG. 6 is a flowchart depicting an example of a process performed at the controller according to the first embodiment.

FIG. 7 is a figure depicting an example of actions of the controller and the drone controlled by the processes depicted in FIG. 5 and FIG. 6.

FIG. 8 is a flowchart depicting an example of processes performed at the drone and the controller according to a second embodiment.

FIG. 9 is a flowchart depicting an example of processes performed at the drone and the controller according to a third embodiment.

FIG. 10 is a flowchart depicting an example of a process performed at the drone according to a fourth embodiment.

FIG. 11 is a figure depicting an example of antennas that can be adopted at the drone and the controller according to each embodiment.

FIG. 12 is a figure depicting an example of antennas that can be adopted at the drone and the controller according to each embodiment.

FIG. 13 is a figure depicting an example of antennas that can be adopted at the drone and the controller according to each embodiment.

FIG. 14 is a figure depicting an example of the hardware configuration of an information processing apparatus that can be used to configure the drone and the controller according to the embodiments.

### DESCRIPTION OF EMBODIMENTS

Embodiments according to the present disclosure are explained below with reference to the figures.

### First Embodiment

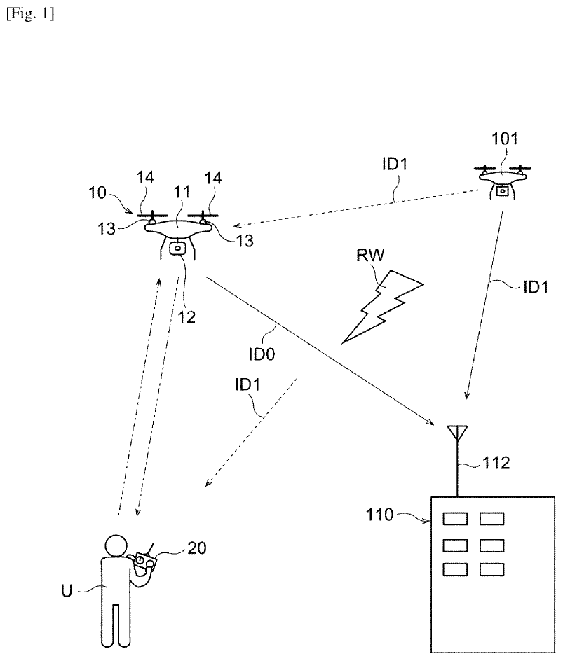

FIG. 1 depicts a situation according to a first embodiment where a drone 10 as a mobile body is caused to fly by a controller 20 as a communication device. The drone 10 is flying by being remotely controlled by the controller 20. Note that in a case where simply the word drone is used, this word means an unmanned aerial vehicle.

### <Overview of Use Environment and Functionalities of Drone and Controller>

First, an overview of a use environment and functionalities of the drone 10 and the controller 20 according to the present embodiment is explained by using FIG. 1. The drone 10 and the controller 20 are capable of bidirectional wireless communication. In FIG. 1, manual operation to control the drone 10 is being performed by an operator U using the controller 20. In this case, for example, by receiving a control command based on an intension of the user transmitted from the controller 20, the drone 10 is controlled on the basis of the control command. The control command is a control command based on the intension of the user for causing the drone 10 to move forward, move backward, turn left, turn right, ascend, descend, and so on. The control command is transmitted as radio waves. The control command is generated by the operator U directly operating the controller 20. On the other hand, the drone 10 may transmit, to the controller 20, information regarding the current position or a captured image, for example. In this case, the information transmitted by the drone 10 is transmitted as radio waves.

In addition to those illustrated as examples mentioned above, the control command may include a command related to a movement of the drone 10 to a target position set by relative or absolute coordinates. In addition, the control command may include a command related to state changes to a target speed, a target angular velocity at a time of making a turn, a target posture and the like, or the like.

In addition, the drone 10 is also capable of autonomous flight (autonomous movement). Specifically, after the controller 20 specifies a route for the drone 10, the drone 10 can autonomously move according to the specified route. In addition, the drone 10 itself can generate a route to a predetermined home position, and autonomously return to the home position according to the generated route. Such a process of autonomously returning to a position is called return-to-home (hereinafter, “RTH”) in some cases.

In addition, the drone 10 is also capable of semi-autonomous flight. Semi-autonomous flight mentioned here means an action state where autonomous flight is performed temporarily during manual flight by manual operation. For example, the drone 10 during manual flight might become unable to communicate with the controller 20, get out of the field of view of a user when the drone 10 gets behind a structure or the like, and so on. In such a case, the drone 10 may temporarily switch to RTH, and perform semi-autonomous flight, for example.

Manual flight, autonomous flight and semi-autonomous flight of the drone 10 like the ones mentioned above may be performed in the field of view of the operator U or may be performed out of the field of view of the operator U. In a case where manual flight is performed out of the field of view, means for enabling recognition of the current position of the drone 10 becomes necessary. For example, such means may be a display that is provided on the controller 20, and displays the current position of the drone 10 or images being captured by the drone 10, or the like.

The controller 20 according to the present embodiment is an apparatus dedicated to operation that is gripped by the operator U, and includes antennas for transmitting control commands. It should be noted that the controller 20 may be a smartphone, a tablet, a personal computer, or the like, for example.

For example, in a case where the controller 20 is configured by using a smartphone or a tablet, the controller 20 may transmit control commands directly according to a communication method such as Bluetooth (registered trademark) or the like. In addition, control commands may be transmitted to the drone 10 according to a communication method such as Wifi via a router or via a router and a base station. In this case, the router and the base station are ones that correspond to a communication device that wirelessly communicates with the drone 10.

FIG. 1 depicts a second-machine drone 101 as a second mobile body. The second-machine drone 101 is being operated by another operator or flying autonomously.

In addition, FIG. 1 depicts an aerial vehicle monitoring facility 110. The aerial vehicle monitoring facility 110 is a facility for monitoring flying objects including unmanned aerial vehicles. The aerial vehicle monitoring facility 110 may be a facility established by a government or a local government for policing aerial vehicles. The aerial vehicle monitoring facility 110 includes an antenna 112. The antenna 112 receives information from flying mobile bodies, and the received information is used for identifying the positions of aerial vehicles. The aerial vehicle monitoring facility 110 may further include sonars or cameras which are not depicted, and further monitor aerial vehicles by using them.

In the situation depicted in FIG. 1, the drone 10 and second-machine drone 101 according to the present embodiment are transmitting specific information ID0 and ID1, respectively, for allowing the aerial vehicle monitoring facility 110 to identify the presences and/or the positions of themselves as represented by solid arrows in the figure. The aerial vehicle monitoring facility 110 uses the specific information ID0 and ID1 for detecting the presences and/or the positions of the drone 10 and the second-machine drone 101, respectively.

In the present embodiment, as an example, the specific information ID0 and ID1 includes information regarding machine-body registration numbers, information regarding machine-body serial numbers, information regarding the current positions and information regarding the current times.

Specifically, as an example, a machine-body registration number according to the present embodiment is a number set for an unmanned aerial vehicle such as the drone 10 or the second-machine drone 101 by a third-party such as a government or a local government. Such a machine-body registration number is a number issued by a government, a local government or the like according to an application for permission of flight of an unmanned aerial vehicle or an application for ownership of an unmanned aerial vehicle. In addition, a machine-body serial number may be a number given by the manufacturer of an unmanned aerial vehicle.

In addition, the information regarding the current positions described above is information regarding the current position of an unmanned aerial vehicle detected by itself, and is information regarding the position of the unmanned aerial vehicle when the unmanned aerial vehicle transmits specific information. An unmanned aerial vehicle for which transmission of specific information is intended typically can detect the position of itself by combining a GNSS (Global Navigation Satellite System), TOF (Time Of Flight), a barometric pressure sensor, a geomagnetic sensor and the like. In addition, the information regarding the current times described above is information regarding a time at which an unmanned aerial vehicle transmits specific information. An unmanned aerial vehicles typically has a clock functionality. In addition, the time information can also be extracted from a signal from a satellite that is received at a GNSS.

The specific information ID0 and ID1 according to the present embodiment is specifically information that the unmanned aerial vehicles are obligated to send when the unmanned aerial vehicles are caused to fly (move) under a remote ID system. The remote ID system imposes a list of obligations requiring an unmanned mobile body to send its machine-body registration number, its machine-body serial number, positional information, a time and authentication information to the aviation bureau, the police and an important facility manager.

Note that remote ID systems are established by, for example, the Ministry of Land, Infrastructure, Transport and Tourism of Japan, the Federal Aviation Administration of the United States, and the European Union Aviation Safety Agency of the European Union. Specific information may be information specified under a remote ID system of some foreign country or a system equivalent to it.

Then, in a use environment like the one mentioned above, the drone 10 according to the present embodiment has a functionality of receiving specific information sent from a second mobile body such as the second-machine drone 101 as represented by a broken-line arrow in FIG. 1. Then, the drone 10 receives specific information as information for identifying the presence and/or position of the second mobile body, and uses the received specific information to control the state of antennas of the drone 10 such as their directionalities. In addition, in the present embodiment, the controller 20 also has a functionality of receiving specific information sent from the second mobile body as represented by a broken-line arrow in FIG. 1. Then, the controller 20 also uses the specific information to control the state of antennas of the controller 20 such as their directionalities.

### <Configuration of Drone>

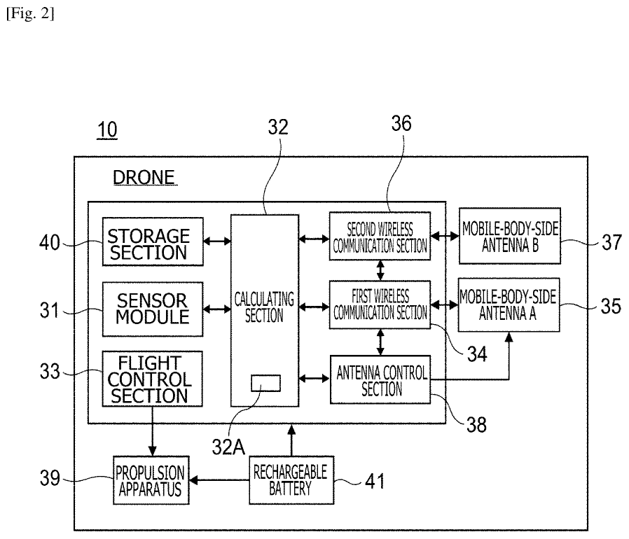

FIG. 2 is a block diagram depicting the configuration of the drone 10. The configuration and the functionalities of the drone 10 are mentioned in detail below. The drone 10 includes a sensor module 31, a calculating section 32, a flight control section 33, a first wireless communication section 34, a mobile-body-side antenna A 35, a second wireless communication section 36, a mobile-body-side antenna B 37, an antenna control section 38, a propulsion apparatus 39, a storage section 40 and, a rechargeable battery 41.

The sensor module 31 includes various types of sensor for detecting the position of the drone 10, and for detecting obstacles around the drone 10. In the present embodiment, as the various types of sensor, the sensor module 31 includes a stereo camera, an IMU (Inertial Measurement Unit), a TOF sensor, a geomagnetic sensor, a barometric pressure sensor, and a GNSS receiving section. Note that the obstacles described above mean any objects that can be obstacles to flight of the drone 10 such as aerial vehicles other than the drone 10, buildings, trees, humans, vehicles, ground surfaces, mountain surfaces, or water surfaces.

The stereo camera captures images of the space around the drone 10 by using two or more image capturing sections, and acquires two or more mutually different image signals. The two or more image signals are used for detection of the distance to an object on images captured from the drone 10. That is, the stereo camera functions as a distance measurement sensor. Note that, in addition to the stereo camera or instead of the stereo camera, any one of or a combination of two or more types of a millimeter-wave-type distance measurement sensor such as a radar, an optical distance measurement sensor such as a LiDAR (Light Detection and Ranging), a ultrasonic wave distance measurement sensor, and the like may be used as a distance measurement sensor.

For example, the IMU includes a triaxial gyro sensor and a tridirectional acceleration sensor, and measures an angular velocity and an acceleration of the drone 10. Information regarding the angular velocity and the acceleration of the drone 10 measured by the IMU is provided to the flight control section 33.

The TOF sensor emits light, and measures the distances to an object around the drone 10, the ground surface and the like on the basis of time that elapses until reflected light of the light returns to the TOF sensor. The light emitted by the TOF sensor may be an infrared ray. The TOF sensor provides information regarding the distances to the object around the drone 10, the ground surface and the like to the flight control section 33.

The geomagnetic sensor measures the orientation of the drone 10 on the basis of measurement of geomagnetism. The geomagnetic sensor provides information regarding the orientation of the drone 10 to the flight control section 33.

The barometric pressure sensor measures barometric pressure. The barometric pressure sensor provides information regarding the barometric pressure to the flight control section 33. The barometric pressure changes depending on the height from the ground surface. Accordingly, the altitude of the drone 10 can be computed on the basis of the barometric pressure measured by the barometric pressure sensor.

The GNSS receiving section receives signals from GPS satellites or other satellites (e.g. Galileo or QZSS), and detects the current position of the drone 10 on the basis of the received signals. In addition, the GNSS receiving section receives time information from the GPS satellite or the other satellites. The GNSS receiving section provides information regarding the current position of the drone 10 and the time information to the flight control section 33. As mentioned later, the flight control section 33 can control the flight condition (driving) of the drone 10 on the basis of information from the sensor module 31.

The calculating section 32 mainly performs data processing inside the drone 10, and data processing between the drone 10 and the outside. For example, the calculating section 32 gives the first wireless communication section 34 an instruction to transmit information to the controller 20, performs a process of providing information received at the mobile-body-side antenna A 35 to the flight control section 33, and so on. In addition, the calculating section 32 also controls a front camera 12 provided to the drone 10 depicted in FIG. 1.

In addition, the calculating section 32 performs a process of analyzing information received at the mobile-body-side antenna B 37, and providing the analyzed information to the antenna control section 38. As mentioned above, the drone 10 has a functionality of receiving specific information regarding a second mobile body sent from the second-machine drone 101 or the like. This functionality is realized by the second wireless communication section 36 mentioned later. The specific information is received at the mobile-body-side antenna B 37, and sent to the calculating section 32 via the second wireless communication section 36. Here, the calculating section 32 includes a positional relation identifying section 32A that analyzes the specific information. The positional relation identifying section 32A identifies a positional relation between the drone 10 and the second mobile body.

The positional relation identifying section 32A identifies whether or not received specific information is one that is sent from a second mobile body, and identifies positional information regarding the second mobile body. This identification is performed by detecting, by demodulation of the specific information, information regarding the machine-body registration number of the second mobile body, information regarding the machine-body serial number of the second mobile body, information regarding the current position of the second mobile body and information regarding the current time, and comparing them with information regarding the drone 10 as appropriate. Whether or not the specific information is one sent from a second mobile body is detected by, for example, comparison with the machine-body serial number or machine-body registration number of the drone 10 retained at the drone 10. Then, the positional relation identifying section 32A further identifies a positional relation between the drone 10 and a second mobile body such as the second-machine drone 101 on the basis of the position of the drone 10 identified by detection information of the sensor module 31, and specific information, specifically the position of the second mobile body identified by the specific information. The positional relation is relative positional coordinates (e.g. X, Y, Z) of the second mobile body as measured relative to the position of the drone 10 as its origin, the orientation (e.g. north northwest) of the second mobile body relative to the drone 10, the orientation and the distance (e.g. north northwest 300 m) of the second unmanned mobile body relative to the drone 10, or the like.

The “positional relation” identified by the positional relation identifying section 32A in the manner mentioned above is sent to the antenna control section 38. As mentioned later in detail, the antenna control section 38 controls the state of the antennas of the drone 10 such as their directionalities on the basis of the provided positional relation.

The flight control section 33 controls driving of the drone 10. For example, the flight control section 33 receives a control command transmitted from the controller 20, and controls driving of the drone 10 on the basis of the control command. Specifically, the flight control section 33 controls driving of the propulsion apparatus 39 on the basis of the control command, and causes the drone 10 to perform an action in a desired state.

In a case where the controller 20 has specified a route for the drone 10, the flight control section 33 controls driving of the drone 10 such that the drone 10 flies autonomously along the route. In addition, for example, in a case where the drone 10 flies autonomously by RTH, the flight control section 33 itself generates a route. Then, the flight control section 33 controls driving of the drone 10 such that the drone 10 flies along the generated route. In a case where the drone 10 moves autonomously along any of the routes, the flight control section 33 can detect the current position or nearby obstacles on the basis of information from the sensor module 31, and change the specified route or the initially generated route as appropriate.

In addition, the flight control section 33 according to the present embodiment can control driving of the drone 10 for avoiding risks on the basis of information from the sensor module 31, for example. Specifically, for example, in a case where an object adjacent to the drone 10 is detected by the TOF sensor of the sensor module 31, the flight control section 33 can control driving of the drone 10 such that the drone 10 is kept away from the object. In addition, for example, in a case where an object adjacent to the drone 10 is detected on the basis of an image signal from the stereo camera, the flight control section 33 can control driving of the drone 10 such that the drone 10 is kept away from the object.

In addition, the flight control section 33 is configured to record positional information regarding the drone 10 on the storage section 40. The recording of positional information regarding the drone 10 may be performed periodically. In addition, the flight control section 33 is configured to record specific information received from the second-machine drone 101 and the like on the storage section 40. The recording of specific information may be performed every time specific information is received.

The first wireless communication section 34 communicates, via the mobile-body-side antenna A 35, with the controller 20 that remotely controls the drone 10. Specifically, the first wireless communication section 34 receives information for driving the drone 10. The information for controlling driving of the drone 10 is a control command transmitted from the controller 20 to the drone 10, for example. In addition, the first wireless communication section 34 transmits positional information regarding the drone 10 or the like to the controller 20.

The mobile-body-side antenna A 35 transmits and receives radio waves, and, in the present embodiment, functions as a transmission antenna, and also functions as a reception antenna. It should be noted that the mobile-body-side antenna A 35 may include a mutually separate transmission antenna and reception antenna. Note that the first wireless communication section 34 is an element corresponding to a mobile-body-side wireless communication section.

The first wireless communication section 34 includes a modulation circuit, a demodulation circuit and the like. For example, in a case where positional information regarding the drone 10, and images captured by the drone 10 are to be transmitted to the controller 20, the first wireless communication section 34 transmits them from the mobile-body-side antenna A 35 as radio wave after modulating the positional information regarding the drone 10. In addition, the first wireless communication section 34 receives, for example, a control command from the controller 20, demodulates the control command, and provides the control command to the flight control section 33 via the calculating section 32.

In the present embodiment, the second wireless communication section 36 performs, via the mobile-body-side antenna B 37, transmission of specific information regarding the drone 10, and reception of specific information from second mobile bodies such as the second-machine drone 101.

The second wireless communication section 36 includes a modulation circuit, a demodulation circuit and the like. For example, in a case where specific information regarding the drone 10 is to be transmitted, the second wireless communication section 36 transmits the specific information from the mobile-body-side antenna B 37 as radio waves after modulating it. Information regarding the machine-body registration number and information regarding the machine-body serial number in the specific information may be recorded on the second wireless communication section 36, for example. Then, the information regarding the machine-body registration number and the information regarding the machine-body serial number may be modulated after being read out at a time of transmission. Information regarding the current position and information regarding the current time in the specific information are modulated after being identified by information detected by the sensor module 31. In addition, the second wireless communication section 36 demodulates specific information from a second mobile body and provides the demodulated specific information to the calculating section 32 (positional relation identifying section 32A).

In the present embodiment, the mobile-body-side antenna B 37 functions as a transmission antenna, and also functions as a reception antenna. It should be noted that the mobile-body-side antenna B 37 may include a mutually separate transmission antenna and reception antenna. The second wireless communication section 36 is an element corresponding to a mobile-body-side second-machine information receiving section. Note that, in the present embodiment, the second wireless communication section 36 acquires specific information regarding a second mobile body from the second mobile body via the mobile-body-side antenna B 37. Instead of this, the second wireless communication section 36 may receive specific information regarding a second mobile body positioned near the drone 10, for example, from the controller 20 or through a network such as the Internet.

Wireless communication methods adopted for the first wireless communication section 34 and the second wireless communication section 36 may be any methods. As an example, they may be ones according to the IEEE802.11 standard, the IEEE802.15.1 standard (Bluetooth (registered trademark)), an OFDM modulation method or other standards. A frequency band used for the wireless communication is the 2.4 GHz band, the 5 GHz band or another frequency band, for example. In addition, the first wireless communication section 34 and the second wireless communication section 36 may be capable of transmission and/or reception of information according to a plurality of wireless communication standards.

It should be noted that the wireless communication method of the second wireless communication section 36 needs to be a method that allows the aerial vehicle monitoring facility 110 or a second machine to receive specific information regarding the drone 10, and allows the drone 10 to receive specific information regarding a second machine. In the present embodiment, the drone 10 transmits and receives information specified under the remote ID system. For example, the remote ID system specifies that information is sent according to the IEEE802.11 standard or Bluetooth (registered trademark). In the present embodiment, specifically, as specific information, information specified under the remote ID system is sent from a second mobile body according to the IEEE802.11 standard or Bluetooth (registered trademark). In view of this, in the present embodiment, the second wireless communication section 36 is configured to transmit, as specific information, information specified by a remote ID according to the IEEE802.11 standard or Bluetooth (registered trademark). In addition, the second wireless communication section 36 is configured to receive, as specific information, information specified by a remote ID according to both the IEEE802.11 standard and Bluetooth (registered trademark). In a case where the second wireless communication section 36 is capable of receiving and demodulating specific information according to two or more wireless communication methods (standards), the second wireless communication section 36 can receive specific information sent from second mobile bodies without omission.

As mentioned above, the antenna control section 38 is provided with a positional relation between the drone 10 and a second mobile body such as the second-machine drone 101 that is identified by the positional relation identifying section 32A in the calculating section 32. Then, the antenna control section 38 controls the state of the antennas of the drone 10 such as their directionalities on the basis of the provided positional relation.

Specifically, the antenna control section 38 controls at least the directionality of the mobile-body-side antenna A 35 used for communication with the controller 20 on the basis of the positional relation between the drone 10 and the second mobile body. The directionality means a reception directionality or a transmission directionality. It should be noted that the antenna control section 38 may change transmission power and/or a used frequency in addition to the directionality of the mobile-body-side antenna A 35, on the basis of the positional relation between the drone 10 and the second mobile body. The transmission power is electric power supplied to the antenna when radio waves are to be transmitted, and is also called antenna power. As the transmission power increases, the energy of radio waves increases, and the distance that the radio waves can reach increases. For example, the used frequency means a particular frequency band (channel) in the 2.4 GHz band.

In FIG. 1, the drone 10 and the second-machine drone 101 are in proximity to each other. In such a situation, for example, a radio wave RW used by the second-machine drone 101 can cause radio wave interference in wireless communication between the drone 10 and the controller 20. Then, in FIG. 1, there is the second-machine drone 101 positioned to the upper right of the drone 10. In such a situation, the antenna control section 38 according to the present embodiment changes the reception directionality of the mobile-body-side antenna A 35 such that the reception signal level for radio waves from an oblique upper side is lowered, for example. Thereby, radio wave interference that can be caused due to the influence of wireless communication of the second mobile body can be avoided or mitigated. The antenna control section 38 may change the reception directionality by controlling radio waves to be received at a plurality of antenna elements or by controlling signals corresponding to received radio waves. In addition, the antenna control section 38 may change the reception directionality by changing the position and/or orientation of the mobile-body-side antenna A 35 such that the reception signal level for radio waves from the upper right side lowers, and the mobile-body-side antenna A 35 is moved away from the second-machine drone 101, for example.

In addition, for example in a case where it is estimated that a used frequency of the drone 10 and a used frequency of the second-machine drone 101 are the same or close to each other, the antenna control section 38 may change the used frequency (channel) of radio waves transmitted from the mobile-body-side antenna A 35. In addition, the antenna control section 38 may raise or lower the transmission power of a mobile-body-side antenna A 35. In these cases also, the status of wireless communication between the drone 10 and the controller 20 can be adjusted favorably, in some cases. Note that a change to the used frequency or the transmission power is preferably made after a change is made to the directionality. It should be noted that a change to the used frequency or the transmission power may be made without making a change to the directionality. In addition, the antenna control section 38 may change the transmission directionality of the mobile-body-side antenna A 35 such that radio waves toward the upper right side decrease or the transmission strength of the radio waves lowers, for example. In this case, the flight stability of the second machine can be enhanced.

The propulsion apparatus 39 includes a plurality of motors 13 depicted in FIG. 1, and a plurality of propellers 14 rotated by the motors 13. Although not depicted, the propulsion apparatus 39 includes also a driver (ESC (Electric Speed Controller)) that controls electric power supply to the motors 13. The flight control section 33 controls the rotation speed of each propeller 14 by controlling a corresponding motor 13 with the driver in the propulsion apparatus 39. Thereby, the flight control section 33 causes the drone 10 to perform actions in a desired state. The drone 10 can ascend straight up by rotating the plurality of propellers 14 uniformly, and can move with inclinations to move forward, move backward, turn left, turn right, and so on by generating rotational differences between the plurality of propellers 14. As depicted in FIG. 1, the motors 13 and the propellers 14 are supported by a body 11.

For example, the storage section 40 is a hard disk, an optical disc, a flash memory or a magnetic tape, but is not limited to these. The rechargeable battery 41 is charged with electric power to be supplied to each section of the drone 10.

### <Configuration of Controller>

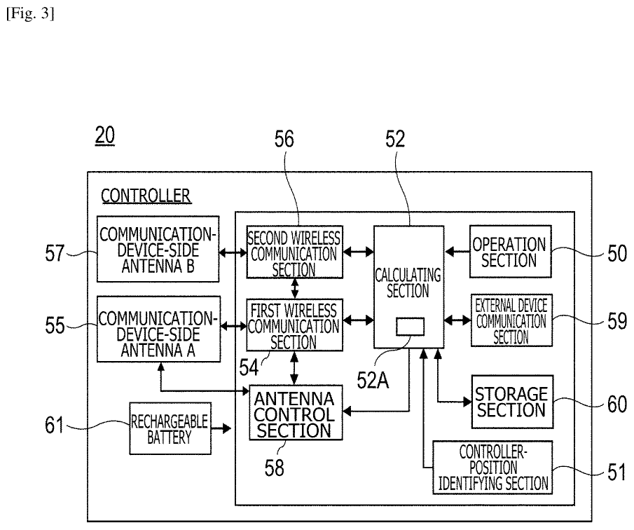

FIG. 3 is a block diagram depicting the configuration of the controller 20. The configuration and the functionalities of the controller 20 are mentioned in detail below. The controller 20 includes an operation section 50, a controller-position identifying section 51, a calculating section 52, a first wireless communication section 54, a controller-side antenna A 55, a second wireless communication section 56, a controller-side antenna B 57, an antenna control section 58, an external device communication section 59, a storage section 60, and a rechargeable battery 61.

The operation section 50 is an interface for the operator U of the drone 10 to input instructions, data, and the like. As an example, the operation section 50 includes at least one of sticks, keys, and buttons. The operation section 50 may be a mechanical component or may be a software component provided to a touch panel (e.g. at least one of keys and buttons is displayed in a partial region on the touch panel). In a case where the operation section 50 is operated by the operator U, an operation signal corresponding to the operation is input to the calculating section 52.

The controller-position identifying section 51 identifies the current position of the controller 20. For example, the controller-position identifying section 51 may identify the current position of the controller 20 on the basis of a signal from hygiene. Specifically, similarly to the case of the drone 10, the controller-position identifying section 51 may be configured by using a GNSS receiving section, or may be configured by using a GPS receiving section that receives only signals from GPS hygiene. Information regarding the current position of the controller 20 identified by the controller-position identifying section 51 is provided to the calculating section 52. Note that the controller-position identifying section 51 is an element corresponding to a communication-device-side position identifying section that identifies the position of the communication device.

The calculating section 52 mainly performs data processing inside the controller 20, and data processing between the controller 20 and the outside. The calculating section 52 generates a control command corresponding to an operation signal in a case where the operation signal is input from the operation section 50 in the manner mentioned above, for example. Then, for example, the calculating section 52 gives the first wireless communication section 54 an instruction to transmit the control command to the drone 10. In addition, the calculating section 52 acquires and identifies information regarding the current position of the drone 10 received at the controller-side antenna A 55 from the drone 10, and acquires and displays information regarding images captured by the drone 10 by using the front camera 12, and so on.

In addition, the calculating section 52 performs a process of analyzing information received at the controller-side antenna B 57, and providing the analyzed information to the antenna control section 58. In the present embodiment, the controller 20 has a functionality of receiving specific information sent from the second-machine drone 101 and the like as mentioned above. This functionality is realized by the second wireless communication section 56 mentioned later. The specific information is received at the controller-side antenna B 57, and sent to the calculating section 52 via the second wireless communication section 56. Here, the calculating section 52 includes a positional relation identifying section 52A that analyzes the specific information. The positional relation identifying section 52A identifies a positional relation between the drone 10 and the second mobile body. In addition, the positional relation identifying section 52A identifies a positional relation between the controller 20 and the second mobile body.

The positional relation identifying section 52A identifies whether or not received specific information is one that is sent from a second mobile body (i.e. a mobile body other than the operation-subject drone 10), and identifies positional information regarding the second mobile body. This identification is performed by detecting, by demodulation of the specific information, information regarding the machine-body registration number of the second mobile body, information regarding the machine-body serial number of the second mobile body, information regarding the current position of the second mobile body and information regarding the current time, and comparing them with information regarding the drone 10 which is communicating with the controller 20, as appropriate. Whether or not the specific information is one sent from a second mobile body is detected by, for example, comparison with the machine-body registration number or machine-body serial number of the drone 10 retained at the controller 20.

The positional relation identifying section 52A according to the present embodiment identifies (i) a positional relation between the drone 10 and a second mobile body such as the second-machine drone 101, and (ii) a positional relation between the controller 20 and the second mobile body such as the second-machine drone 101, on the basis of the position of the drone 10 received from the drone 10, the position of the controller 20 identified by the controller-position identifying section 51 and the received specific information. The positional relation is relative positional coordinates (e.g. X, Y, Z) of the second mobile body as measured relative to the position of the drone 10 or the controller 20 as its origin, the orientation (e.g. north northwest) of the second mobile body relative to the drone 10 or the controller 20, the orientation and the distance (e.g. north northwest 300 m) of the second mobile body relative to the drone 10 or the controller 20, or the like.

The “positional relations (i) and (ii)” identified by the positional relation identifying section 52A in the manner mentioned above are sent to the antenna control section 58. As mentioned later in detail, the antenna control section 58 controls the state of the antennas of the controller 20 such as their directionalities on the basis of the provided positional relations. Note that the positional relation identifying section 52A may identify only one of (i) the positional relation between the drone 10 and the second mobile body, and (ii) the positional relation between the controller 20 and the second mobile body.

The first wireless communication section 54 communicates with the drone 10 via the controller-side antenna A 55. Specifically, the first wireless communication section 54 transmits information for driving the drone 10. The information for controlling driving of the drone 10 is a control command generated at the calculating section 52, or the like. In addition, the first wireless communication section 54 receives, from the drone 10, positional information regarding the drone 10, information regarding images captured by the drone 10 by using the front camera 12, and the like.

The controller-side antenna A 55 transmits and receives radio waves, and, in the present embodiment, functions as a transmission antenna, and also functions as a reception antenna. It should be noted that the controller-side antenna A 55 may include a mutually separate transmission antenna and reception antenna. Note that the first wireless communication section 54 is an element corresponding to a communication-device-side wireless communication section.

The first wireless communication section 54 includes a modulation circuit, a demodulation circuit, and the like. For example, in a case where a control command is to be transmitted to the drone 10, the first wireless communication section 54 modulates a control command, and then transmits the control command as a radio wave from the controller-side antenna A 55. In addition, the first wireless communication section 54 receives positional information regarding the drone 10 from the drone 10, demodulates the positional information, and provides the positional information to the calculating section 52.

The second wireless communication section 56 receives specific information from a second mobile body such as the second-machine drone 101 via the controller-side antenna B 57. The second wireless communication section 56 can also receive specific information regarding the drone 10 sent by the drone 10.

The second wireless communication section 56 includes a demodulation circuit and the like. The second wireless communication section 56 demodulates specific information from a second mobile body and provides the demodulated specific information to the calculating section 52 (positional relation identifying section 52A). Note that the second wireless communication section 56 is an element corresponding to a communication-device-side second-machine information receiving section. In the present embodiment, the second wireless communication section 56 performs direct reception of specific information from a second mobile body such as the second-machine drone 101. Instead of this, the second wireless communication section 56 may receive, from the drone 10, specific information from a second mobile body received by the drone 10.

Wireless communication methods adopted for the first wireless communication section 54 and the second wireless communication section 56 may be any methods. As an example, they may be ones according to the IEEE802.11 standard, the IEEE802.15.1 standard (Bluetooth (registered trademark)), an OFDM modulation method, or other standards. A frequency band used for the wireless communication is the 2.4 GHz band, the 5 GHz band, or another frequency band, for example. In addition, the first wireless communication section 54 and the second wireless communication section 56 may be capable of transmission and/or reception of information according to a plurality of wireless communication standards.

It should be noted that the first wireless communication section 54 supports a communication method of the drone-10-side first wireless communication section 54. In addition, the wireless communication method of the second wireless communication section 56 needs to be a method that enables reception of specific information regarding second machines. In the present embodiment, the controller 20 transmits and receives information specified under the remote ID system. In the present embodiment, specifically, as specific information, information specified under the remote ID system is sent from a second mobile body according to the IEEE802.11 standard or Bluetooth (registered trademark). In view of this, in the present embodiment, the second wireless communication section 56 is configured to receive, as specific information, information specified by a remote ID according to both the IEEE802.11 standard and Bluetooth (registered trademark).

The antenna control section 58 is provided with (i) the positional relation between the drone 10 and the second mobile body, and (ii) the positional relation between the controller 20 and the second mobile body identified by the positional relation identifying section 52A in the calculating section 52 as mentioned above. Then, the antenna control section 58 controls the state of the antennas of the controller 20 such as their directionalities on the basis of the provided positional relations.

Specifically, the antenna control section 58 controls at least the directionality of the controller-side antenna A 55 used for communication with the drone 10 on the basis of the positional relation between the controller 20 and the second mobile body. It should be noted that the antenna control section 58 may change transmission power and/or a used frequency in addition to the directionality of the controller-side antenna A 55, on the basis of the positional relation between the controller 20 and the second mobile body.

In FIG. 1, the radio wave RW used by the second-machine drone 101 can cause radio wave interference in wireless communication between the drone 10 and the controller 20. Then, in FIG. 1, there is the second-machine drone 101 positioned to the upper right of the controller 20. In such a situation, the antenna control section 58 according to the present embodiment changes the reception directionality of the controller-side antenna A 55 such that the reception signal level for radio waves from the upper right side is lowered, for example. Thereby, radio wave interference that can be caused due to the influence of wireless communication of the second mobile body can be avoided or mitigated. The antenna control section 58 may change the reception directionality by controlling radio waves to be received at a plurality of antenna elements or by controlling signals corresponding to received radio waves. In addition, the antenna control section 58 may change the reception directionality by changing the position and/orientation of the controller-side antenna A 55 such that the reception signal level for radio waves from the upper right side lowers, and the controller-side antenna A 55 is moved away from the second-machine drone 101, for example.

In addition, for example in a case where it is estimated that a used frequency of the controller 20 and a used frequency used at the second-machine drone 101 are the same or close to each other, the antenna control section 58 may change the used frequency of radio waves transmitted from the controller-side antenna A 56. In addition, the antenna control section 58 may raise or lower the transmission power of the controller-side antenna 56A. In these cases also, the status of wireless communication between the drone 10 and the controller 20 can be adjusted favorably, in some cases. In addition, the antenna control section 58 may change the transmission directionality of the controller-side antenna A 55 such that radio waves toward the upper right side decrease or the transmission strength of the radio waves lowers, for example. In this case, the flight stability of the second machine can be enhanced.

The external device communication section 59 is connected with a network such as the Internet and performs transmission and reception of information. Note that, in the present embodiment, the second wireless communication section 56 acquires specific information regarding a second mobile body from the second mobile body via the controller-side antenna B 57. Instead of this, the external device communication section 59 may receive specific information regarding a second mobile body positioned near the drone 10 through a network such as the Internet. In addition, for example, the storage section 60 is a hard disk, an optical disc, a flash memory or a magnetic tape, but is not limited to these. The rechargeable battery 61 is charged with electric power to be supplied to each section of the controller 20.

### <Example of Configuration of Antennas>

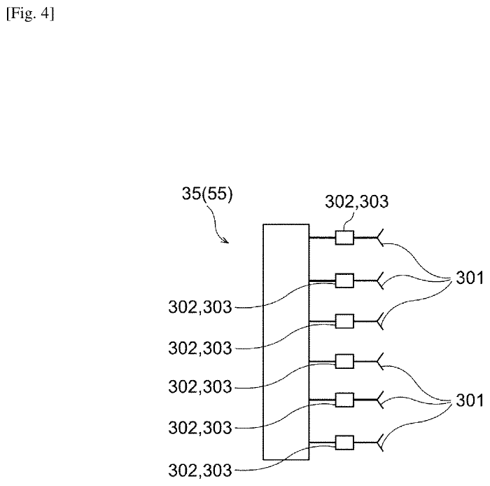

FIG. 4 depicts an example of the configuration of the antennas provided on the drone 10 and the controller 20. FIG. 4 schematically depicts the configuration of an array antenna. As an example, the mobile-body-side antenna A 35 in the drone 10 and the controller-side antenna A 55 in the controller 20 according to the first embodiment are configured by using the array antenna depicted in FIG. 4.

The array antenna depicted in FIG. 4 includes a plurality of antenna elements 301, and a phase adjuster 302 and an amplitude adjuster 303 connected to each antenna element 301. The array antenna transmit a radio wave from each antenna element 301, and can form a desired transmission directionality by adjusting the phase and/or amplitude of the radio wave transmitted from the antenna element 301, or by adjusting the phase and/or amplitude of a signal corresponding to the radio wave to be transmitted. Each antenna element 301 receives input of an electric signal corresponding to a radio wave, converts the electric signal into a radio wave, and transmits the radio wave. In addition, the array antenna can form a desired reception directionality by adjusting the phase and/or amplitude of a radio wave received at each antenna element 301, or by adjusting the phase and/or amplitude of a signal corresponding to the received radio wave.

In a case where the mobile-body-side antenna A 35 and the controller-side antenna A 55 are configured by using array antennas, the antenna control section 38 in the drone 10 performs control by adjusting the phase and/or amplitude of a radio wave transmitted by each of the plurality of antenna elements 301, or by adjusting the phase and/or amplitude of a signal corresponding to the transmitted radio wave, on the basis of a positional relation between the drone 10 and a second mobile body, for example. Thereby, a transmission directionality as a directionality can be changed. In addition, the antenna control section 38 performs control by adjusting the phase and/or amplitude of a radio wave received by each of the plurality of antenna elements 301, and/or by adjusting the phase and/or amplitude of a signal corresponding to the received radio wave, on the basis of a positional relation between the drone 10 and a second mobile body, for example. Thereby, a reception directionality as a directionality can be changed. The antenna control section 58 in the controller 20 also can control a directionality similarly.

### <Control of Drone (Mobile Body) and Controller (Communication Device)>

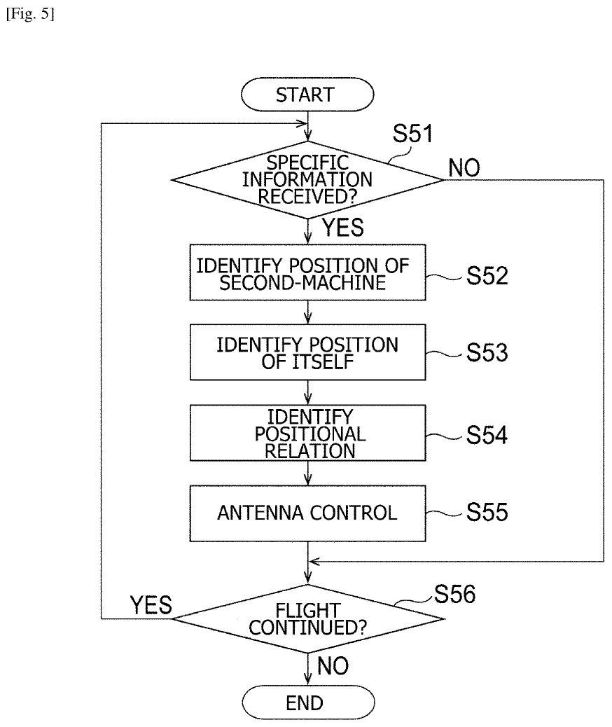

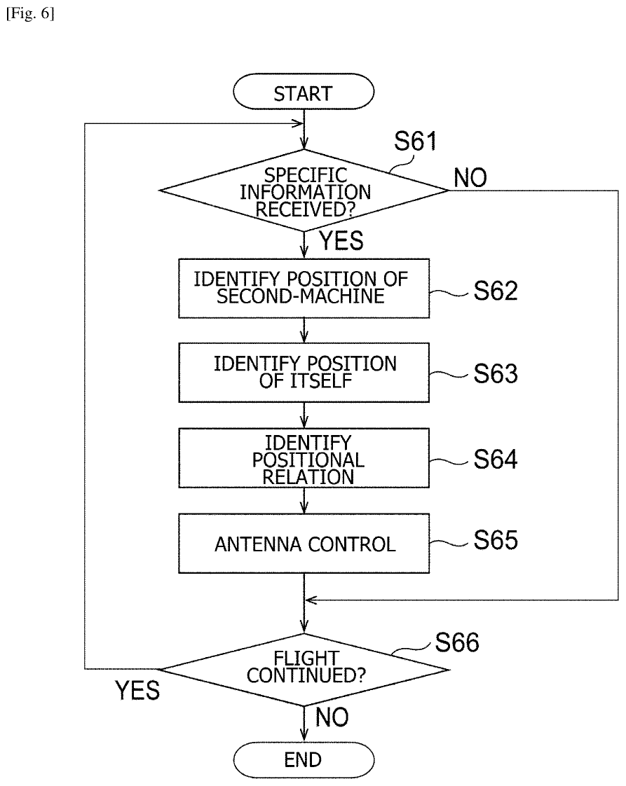

Next, an example of processes performed at the drone 10 and the controller 20 according to the first embodiment is explained with reference to flowcharts depicted in FIG. 5 and FIG. 6. FIG. 5 depicts a process at the drone 10, and FIG. 6 depicts a process at the controller 20.

The process at the drone 10 depicted in FIG. 5 is started when the drone 10 is turned on. After the process is started, first, the drone 10 checks whether or not specific information from a second mobile body such as the second-machine drone 101 (information regarding the machine-body registration number, the position of the second mobile body, etc.) has been received (Step S51).

In a case where at Step S51 specific information from a second mobile body has been received (YES), the drone 10 identifies the position of the second mobile body (second-machine position) on the basis of the specific information regarding the second mobile body (Step S52). The identification of the positional information regarding the second mobile body is performed by the positional relation identifying section 32A.

Next, the drone 10 identifies the position of the drone 10. The identification of the position of the drone 10 is performed on the basis of information detected by the sensor module 31 (Step S53).

Next, the drone 10 identifies a positional relation between the drone 10 and the second mobile body such as the second-machine drone 101 on the basis of the position of the drone 10 and the specific information received at Step S52, specifically the position of the second mobile body identified by the specific information (Step S54). The identification of the positional relation is performed by the positional relation identifying section 32A.

Then, the drone 10 controls at least the directionality of the mobile-body-side antenna A 35 of the drone 10 on the basis of the positional relation between the drone 10 and the second mobile body such as the second-machine drone 101 identified by the positional relation identifying section 32A (Step S55).

Next, the drone 10 determines whether or not flight of itself is being continued (Step S56). Note that, in a case where at Step S51 reception of specific information from a second mobile body is not confirmed (NO), the process proceeds from Step S51 to Step S56. Then, in a case where it is determined at Step S56 that the flight of the drone 10 is being continued (YES), the process returns to Step S51. On the other hand, in a case where it is not determined at Step S56 that the flight of the drone 10 is being continued (NO), the process ends.

The process at the controller 20 depicted in FIG. 6 is started when the controller 20 is turned on. After the process is started, first, the controller 20 checks whether or not specific information from a second mobile body such as the second-machine drone 101 which is not the operation subject (information regarding the machine-body registration number, the position of the second mobile body, etc.) has been received (Step S61).

In a case where at Step S61 specific information from a second mobile body has been received (YES), the controller 20 identifies the position of the second mobile body (second-machine position) on the basis of the specific information regarding the second mobile body (Step S62). The identification of the positional information regarding the second mobile body is performed by the calculating section 52.

Next, the controller 20 identifies the position of the controller 20. The identification of the position of the controller 20 is performed on the basis of information detected at the controller-position identifying section 51 (Step S63). In addition, in the present embodiment, the position of the operation-subject drone 10 also is identified at Step S63.

Next, the controller 20 identifies (i) a positional relation between the drone 10 and the second mobile body, and (ii) a positional relation between the controller 20 and the second mobile body on the basis of the position of the drone 10 received from the drone 10, the position of the controller 20 identified by the controller-position identifying section 51 and the received specific information regarding the second mobile body (specifically, the position of the second mobile body identified by the specific information) (Step S64). The identification of the positional relation is performed by the positional relation identifying section 52A.

Then, the controller 20 controls at least the directionality of the controller-side antenna A 55 of the controller 20 on the basis of the positional relation between the drone 10 and the second mobile body such as the second-machine drone 101 identified by the positional relation identifying section 52A (Step S65).

Next, the controller 20 determines whether or not flight of the drone 10 is being continued (Step S66). Note that, in a case where at Step S61 reception of specific information from a second mobile body is not confirmed (NO), the process proceeds from Step S61 to Step S66. Then, in a case where it is determined at Step S66 that the flight of the drone 10 is being continued (YES), the process returns to Step S61. On the other hand, in a case where it is not determined at Step S66 that the flight of the drone 10 is being continued (NO), the process ends.

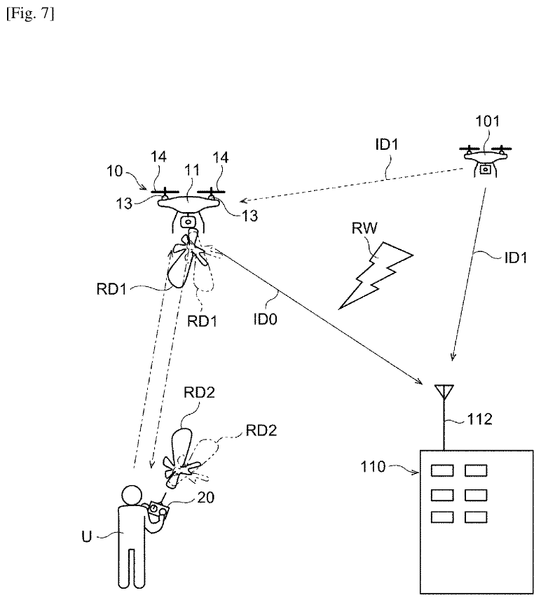

FIG. 7 is a figure depicting an example of actions of the controller 20 and the drone 10 controlled by the processes depicted in FIG. 5 and FIG. 6. In FIG. 7, the radio wave RW used by the second-machine drone 101 can cause radio wave interference in wireless communication between the drone 10 and the controller 20. Then, in FIG. 1, there is the second-machine drone 101 positioned to the upper right of the drone 10 and the controller 20.

At Step S54 in FIG. 5, as the positional relation between the drone 10 and the second mobile body, that the second-machine drone 101 is positioned to the upper right of the drone 10 is detected. More specifically, a positional relation such as relative positional coordinates (e.g. 400 (m), 50 (m), 80 (m)) of the second-machine drone 101 as measured relative to the position of the drone 10 as their origin is identified. Then, in FIG. 7, the antenna control section 38 changes the reception directionality of the mobile-body-side antenna A 35 such that the reception signal level for radio waves from, for example, the upper right side lowers, on the basis of the positional relation between the drone 10 and the second-machine drone 101. Specifically, the reception directionality RD1 of the mobile-body-side antenna A 35 is changed from the state represented by a long-dashed double-short-dashed line to the state represented by a solid line. That is, the reception directionality RD1 is changed such that a main beam regarding the reception directionality RD1 inclines away from the second-machine drone 101.

In addition, at Step S64 in FIG. 6, as the positional relation between the controller 20 and the second mobile body, that the second-machine drone 101 is positioned to the upper right of the controller 20 is detected. More specifically, a positional relation such as relative positional coordinates (e.g. 500 (m), 150 (m), 100 (m)) of the second-machine drone 101 as measured relative to the position of the controller 20 as their origin is identified. Then, in FIG. 7, the antenna control section 58 changes the reception directionality of the controller-side antenna A 55 such that the reception signal level for radio waves from, for example, the upper right side lowers, on the basis of the positional relation between the controller 20 and the second-machine drone 101. Specifically, the reception directionality RD2 of the controller-side antenna A 55 represented by a long-dashed double-short-dashed line is changed from the state represented by the long-dashed double-short-dashed line to the state represented by a solid line. That is, the reception directionality RD2 is changed such that a main beam regarding the reception directionality RD2 inclines away from the second-machine drone 101.

Note that, in the example explained with reference to FIG. 7, the antenna control section 58 changes the reception directionality of the controller-side antenna A 55 on the basis of the positional relation between the controller 20 and the second-machine drone 101. Instead of this, the antenna control section 58 may change the state of the reception directionality of the controller-side antenna A 55 and the like on the basis of the positional relation between the drone 10 and the second mobile body such as the second-machine drone 101 or on the basis of both this and the positional relation between the controller 20 and the second mobile body. In this case, the controller 20 may not include the controller-position identifying section 51 that identifies the position of the controller 20. In addition, the controller 20 may not be provided with the antenna control section 58 but may be provided with a notifying section that notifies the positional relation between the drone 10 and a second mobile body to the controller 20. In this case, the operator may change the state of the antennas by changing the operation position of her/himself on the basis of the notification. In addition, the drone-10-side antenna control section 38 changes the reception directionality of the drone-side antenna A 35 on the basis of the positional relation between the drone 10 and the second-machine drone 101. Instead of this, the antenna control section 38 may change the state of the reception directionality of the mobile-body-side antenna A 35 and the like on the basis of the positional relation between the controller 20 and the second mobile body such as the second-machine drone 101 or on the basis of both this and the positional relation between the drone 10 and the second mobile body.

The drone 10 according to the present embodiment explained above includes the first wireless communication section 34 that transmits and receives radio waves via the mobile-body-side antenna A 35, and the antenna control section 38 that controls at least the directionality of the mobile-body-side antenna A 35 on the basis of a positional relation between the drone 10 and the second mobile body. Specifically, the drone 10 according to the present embodiment includes the second wireless communication section 36 corresponding to the second-machine information receiving section that receives specific information that is sent from a second mobile body, and is for identifying the presence and/or position of the second mobile body, and the positional relation identifying section 32A that identifies the positional relation between the drone 10 and the second mobile body on the basis of the drone 10 and the specific information received at the second wireless communication section 36.

In addition, the controller 20 according to the present embodiment includes the first wireless communication section 54 that is a communication device that wirelessly communicates with the drone 10, and transmits and receives radio waves via the controller-side antenna A 55, the controller-position identifying section 51 corresponding to the position identifying section that identifies the position of the controller 20, the second wireless communication section 56 corresponding to the second-machine information receiving section that receives specific information that is sent from a second mobile body, and is for identifying the presence and/or position of the second mobile body, the positional relation identifying section 52A that identifies a positional relation between the controller 20 and the second mobile body on the basis of the position of the controller 20 and the specific information received at the second wireless communication section 56, and the antenna control section 58 that controls at least the directionality of the controller-side antenna A 55 on the basis of the positional relation between the controller 20 and the second mobile body.

According to these drone 10 and controller 20, at least directionalities of the antennas can be changed such that radio wave interference that can be caused by the influence of wireless communication of a second mobile body is avoided or mitigated. Thereby, deterioration of the status of wireless communication between the drone 10 and the controller 20 due to the influence of the wireless communication performed by the second mobile body can be reduced.

Specifically, the antenna control section 38 in the drone 10 changes the reception directionality of the mobile-body-side antenna A 35 on the basis of the positional relation between the drone 10 and the second mobile body. In addition, the antenna control section 58 in the controller changes the reception directionality of the controller-side antenna A 55 on the basis of the positional relation between the controller 20 and the second mobile body. Thereby, deterioration of the status of wireless communication between the drone 10 and the controller 20 due to the influence of the wireless communication performed by the second mobile body can be reduced.

Then, each of the mobile-body-side antenna A 35 and the controller-side antenna A 55 according to the present embodiment is an array antenna including a plurality of antenna elements 301. In this case, each of the mobile-body-side antenna A 35 and the controller-side antenna A 55 changes the reception directionality by controlling at least one of the phase and amplitude of radio waves received by the plurality of antenna elements 301. In this case, the hardware configuration can be simplified.

On the other hand, the antenna control section 38 in the drone 10, and the antenna control section 58 in the controller may change transmission power or used frequencies of the mobile-body-side antenna A 35 and the controller-side antenna A 55. In this case, for example, the status of wireless communication between the drone 10 and the controller 20 can be improved effectively by combining elements used to change the antenna state.

In addition, in the present embodiment, specific information received by the drone 10 and the controller 20 from a second mobile body includes at least the machine-body registration number of the second mobile body, and positional information regarding the second mobile body. In this case, demodulation of the specific information enables easy identification of the presence of the second mobile body, and other positional information. Note that, for example, even in a case only identification information such as the machine-body registration number of the second mobile body is received, the orientation of the second mobile body can be estimated by identifying the reception direction of radio waves. Then, the state of the antennas may be controlled on the basis of this estimation. It should be noted that, in a case where the machine-body registration number of the second mobile body, and the positional information regarding the second mobile body are received, this enables easy and economical identification of the presence of the second mobile body and other positional information.

In addition, the specific information received by the drone 10 and the controller 20 according to the present embodiment is information specified under the remote ID system, and is information that second mobile bodies are obligated to transmit. In this case, if the drone 10 and the controller 20 are given functionalities to enable reception of the information specified under the remote ID system, the drone 10 and the controller 20 can grasp the presence and/or position of a second mobile body. Accordingly, the drone 10 and controller 20 according to the present embodiment can identify the position of a second mobile body economically with simple hardware configuration.

Other embodiments are explained below. Portions in other embodiments explained below that are identical to those in the embodiment mentioned above are given identical reference characters.

### Second Embodiment

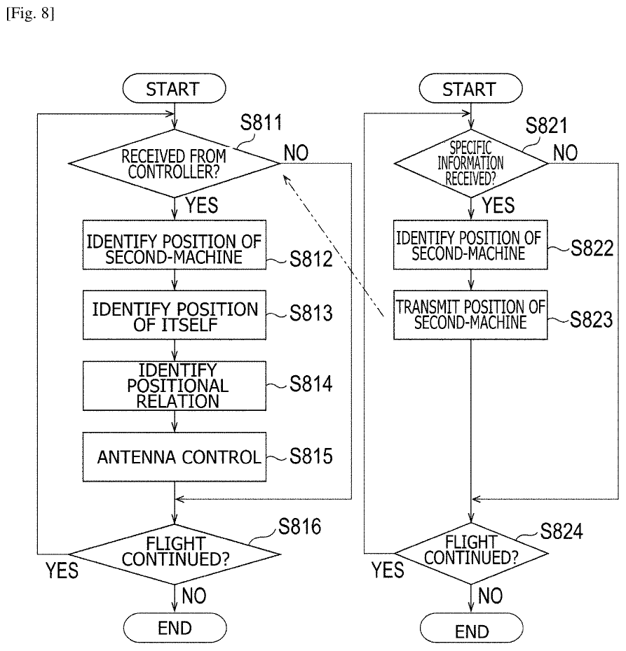

FIG. 8 depicts an example of processes performed at the drone 10 and the controller 20 according to a second embodiment. In FIG. 8, a flowchart depicting a process performed at the drone 10 and a flowchart depicting a process performed at the controller 20 are depicted next to each other.

In the present embodiment, the drone 10 does not have a functionality of receiving specific information regarding a second mobile body transmitted from the second mobile body. Specifically, the drone 10 does not include the second wireless communication section 36 and the mobile-body-side antenna B 37. On the other hand, the drone 10 receives, at the first wireless communication section 34, information regarding the position of a second mobile body transmitted from the controller 20. Then, the drone 10 identifies a positional relation between the drone 10 and the second mobile body, and controls the antenna state on the basis of the position of itself and the position of the second mobile body. The controller 20 identifies the position of the second mobile body on the basis of the specific information from the second mobile body, and transmits the position of the second mobile body. As in the first embodiment, the specific information includes information regarding the machine-body registration number, information regarding the machine-body serial number, information regarding the current position, and information regarding the current time. More specifically, the specific information is information that an unmanned aerial vehicle is obligated to send under the remote ID system.

The process depicted in FIG. 8 is started when the drone 10 and the controller 20 are turned on. After the process is started, first, the drone 10 checks whether or not positional information regarding a second mobile body has been received from the controller 20 (Step S811).

In a case where at Step S811 positional information regarding a second mobile body has been received (YES), the drone 10 identifies the position of the second mobile body (second-machine position) (Step S812). Next, the drone 10 identifies the position of the drone 10 (Step S813).

Next, the drone 10 identifies a positional relation between the drone 10 and the second mobile body on the basis of the position of the drone 10 and the position of the second mobile body (Step S814). Then, the drone 10 controls the state of the mobile-body-side antenna A 35 of the drone 10 such as its directionality on the basis of the positional relation between the drone 10 and the second mobile body identified at Step S814 (Step S815).

Next, the drone 10 determines whether or not flight of itself is being continued (Step S816). Note that, in a case where at Step S811 reception of positional information regarding a second mobile body is not confirmed (NO), the process proceeds from Step S811 to Step S816. Then, in a case where it is determined at Step S816 that the flight of the drone 10 is being continued (YES), the process returns to Step S811. On the other hand, in a case where it is not determined at Step S816 that the flight of the drone 10 is being continued (NO), the process ends.

On the other hand, first, the controller 20 checks whether or not specific information from a second mobile body (information regarding the machine-body registration number, the position of the second mobile body, etc.) has been received (Step S821).

In a case where at Step S821 specific information from a second mobile body has been received (YES), the controller 20 identifies the position of the second mobile body (second-machine position) on the basis of the specific information regarding the second mobile body (Step S822).

Next, the controller 20 transmits, to the drone 10, information regarding the position of the second mobile body identified at Step S822 (Step S823; see a long-dashed-double-short-dashed-line arrow). Thereafter, the controller 20 determines whether or not flight of the drone 10 is being continued (Step S824). Note that, in a case where at Step S821 reception of specific information from a second mobile body is not confirmed (NO), the process proceeds from Step S821 to Step S824. Then, in a case where it is determined at Step S824 that the flight of the drone 10 is being continued (YES), the process returns to Step S821. On the other hand, in a case where it is not determined at Step S824 that the flight of the drone 10 is being continued (NO), the process ends.

According to the second embodiment explained above, since a functionality of receiving specific information from a second mobile body is not used at the drone 10, the hardware configuration of the drone 10 can be simplified.

### Third Embodiment

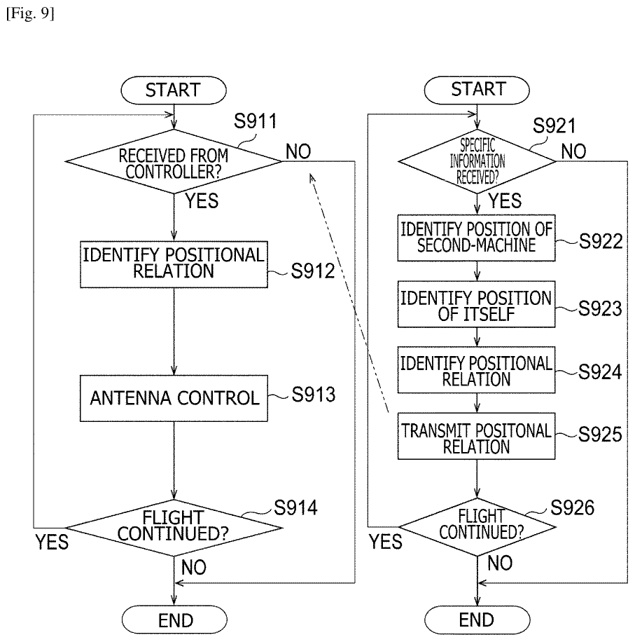

FIG. 9 depicts an example of processes performed at the drone 10 and the controller 20 according to a third embodiment. In FIG. 9, a flowchart depicting a process performed at the drone 10 and a flowchart depicting a process performed at the controller 20 are depicted next to each other.

In the present embodiment, the drone 10 does not have a functionality of receiving specific information regarding a second mobile body transmitted from the second mobile body. Specifically, the drone 10 does not include the second wireless communication section 36 and the mobile-body-side antenna B 37. On the other hand, the drone 10 receives, at the first wireless communication section 34, information regarding a positional relation between the drone 10 and the second mobile body transmitted from the controller 20. Then, the drone 10 identifies a positional relation between the drone 10 and the second mobile body, and controls the antenna state on the basis of the position of itself and the position of the second mobile body. The controller 20 identifies the positional relation on the basis of the specific information from the second mobile body, and transmits the positional relation. As in the embodiments mentioned above, the specific information includes information regarding the machine-body registration number, information regarding the machine-body serial number, information regarding the current position and information regarding the current time. More specifically, the specific information is information that an unmanned aerial vehicle is obligated to send under the remote ID system when the unmanned aerial vehicle is caused to fly (move).

The process depicted in FIG. 9 is started when the drone 10 and the controller 20 are turned on. After the process is started, first, the drone 10 checks whether or not information regarding a positional relation between the drone 10 and the second mobile body has been received from the controller 20 (Step S911).

In a case where at Step S911 information regarding a positional relation between the drone 10 and the second mobile body has been received (YES), the drone 10 identifies the positional relation between the drone 10 and the second mobile body (Step S912).

Next, the drone 10 controls the state of the mobile-body-side antenna A 35 of the drone 10 such as its directionality on the basis of the positional relation between the drone 10 and the second mobile body identified at Step S912 (Step S913).

Next, the drone 10 determines whether or not flight of itself is being continued (Step S914). Note that, in a case where at Step S911 reception of positional information regarding a second mobile body is not confirmed (NO), the process proceeds from Step S911 to Step S914. Then, in a case where it is determined at Step S914 that the flight of the drone 10 is being continued (YES), the process returns to Step S911. On the other hand, in a case where it is not determined at Step S914 that the flight of the drone 10 is being continued (NO), the process ends.

On the other hand, first, the controller 20 checks whether or not specific information from a second mobile body (information regarding the machine-body registration number, the position of the second mobile body, etc.) has been received (Step S921).

In a case where at Step S921 specific information from a second mobile body has been received (YES), the controller 20 identifies the position of the second mobile body (second-machine position) on the basis of the specific information regarding the second mobile body (Step S922).

Next, the controller 20 identifies the position of the operation-subject drone 10 (Step S923). Here, the controller 20 identifies the position of the drone 10 on the basis of information received from the drone 10. Then, the controller 20 identifies a positional relation between the drone 10 and the second mobile body on the basis of the information received at Step S922 and Step S923 (Step S924). Then, the controller 20 transmits, to the drone 10, information regarding the positional relation between the drone 10 and the second mobile body identified at Step S924 (Step S925; see a long-dashed-double-short-dashed-line arrow).

Thereafter, the controller 20 determines whether or not flight of the drone 10 is being continued (Step S926). Note that, in a case where at Step S921 reception of specific information from a second mobile body is not confirmed (NO), the process proceeds from Step S921 to Step S926. Then, in a case where it is determined at Step S926 that the flight of the drone 10 is being continued (YES), the process returns to Step S921. On the other hand, in a case where it is not determined at Step S926 that the flight of the drone 10 is being continued (NO), the process ends.

According to the third embodiment explained above, since a functionality of receiving specific information from a second mobile body, and a functionality of calculating a positional relation between the drone 10 and the second mobile body are not used at the drone 10, the hardware configuration of the drone 10 can be simplified.

### Fourth Embodiment

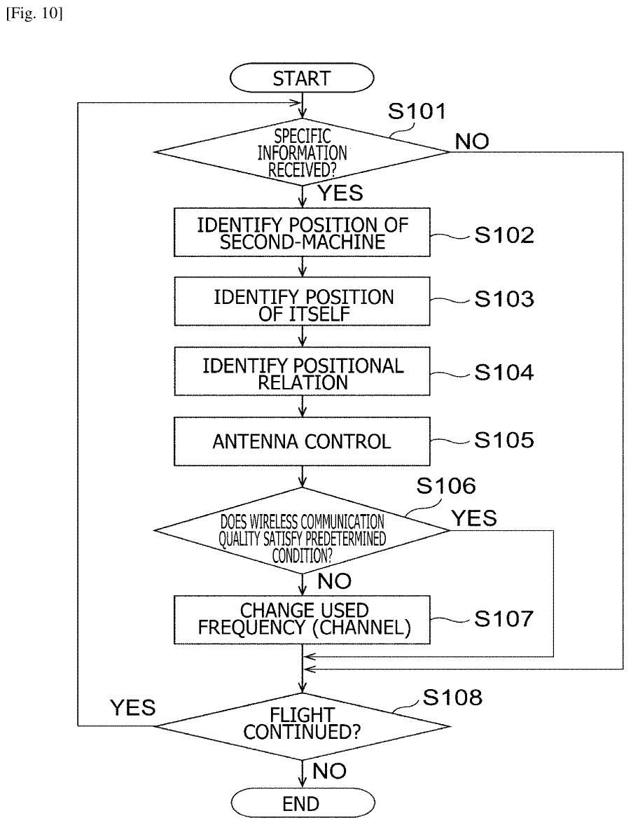

FIG. 10 is a flowchart depicting an example of a process performed at the drone 10 according to a fourth embodiment. In the present embodiment, the drone 10 changes the reception directionality of the mobile-body-side antenna A 35 on the basis of a positional relation between the drone 10 and a second mobile body, and thereafter changes a used frequency used at the mobile-body-side antenna A 35 according to the state. As in the first embodiment, the drone 10 identifies the position of a second mobile body on the basis of specific information regarding the second mobile body from the second mobile body. As in the embodiments mentioned above, the specific information includes information regarding the machine-body registration number, information regarding the machine-body serial number, information regarding the current position and information regarding the current time. More specifically, the specific information is information that an unmanned aerial vehicle is obligated to send under the remote ID system.

The process depicted in FIG. 10 is started when the drone 10 is turned on. After the process is started, first, the drone 10 checks whether or not specific information from a second mobile body (information regarding the machine-body registration number, the position of the second mobile body, etc.) has been received (Step S101).

In a case where at Step S101 specific information from a second mobile body has been received, the drone 10 identifies the position of the second mobile body (second-machine position) on the basis of the specific information regarding the second mobile body (Step S102). Next, the drone 10 identifies the position of the drone 10 (Step S103).

Next, the drone 10 identifies a positional relation between the drone 10 and the second mobile body on the basis of the position of the drone 10 and the specific information received at Step S101, specifically the position of the second mobile body identified by the specific information (Step S104).

Then, the drone 10 changes the reception directionality of the mobile-body-side antenna A 35 of the drone 10 on the basis of the positional relation between the drone 10 and the second mobile body identified at Step S104 (Step S105).

Next, the drone 10 determines whether or not the quality of wireless communication with the controller 20 satisfies a predetermined condition (Step S106). A state where the wireless communication quality satisfies the predetermined condition may be a state where the reception signal level is equal to or greater than a predetermined value. In addition, a state where the wireless communication quality satisfies the predetermined condition may be a state where noise components in received radio waves are equal to or smaller than a predetermined value.

Then, in a case where it is not determined at Step S106 that the wireless communication quality satisfies the predetermined condition, the drone 10 changes a used frequency of the mobile-body-side antenna A 35. Changing used frequency means changing a frequency channel. For example, in a case where the 2.4 GHz band is used for wireless communication, and available bands are set to channels 1 to 14, for example, changing the channel to be used from channel 1 to channel 14 corresponds to changing the used frequency.

Next, the drone 10 determines whether or not flight of itself is being continued (Step S108). Note that, in a case where at Step S101 reception of specific information from a second mobile body is not confirmed, the process proceeds from Step S101 to Step S108. In addition, in a case where it is determined at Step S106 that the wireless communication quality satisfies the predetermined condition, the process proceeds from Step S106 to Step S108. Then, in a case where it is determined at Step S108 that the flight of the drone 10 is being continued, the process returns to Step S101. On the other hand, in a case where it is not determined at Step S108 that the flight of the drone 10 is being continued, the process ends.

According to the fourth embodiment explained above, by changing two types of state of the mobile-body-side antenna A 35, the status of wireless communication between the drone 10 and the controller 20 can be improved effectively. Note that a processes similar to the process in FIG. 10 may be performed at the controller 20.

### <<Configuration of Antennas>>

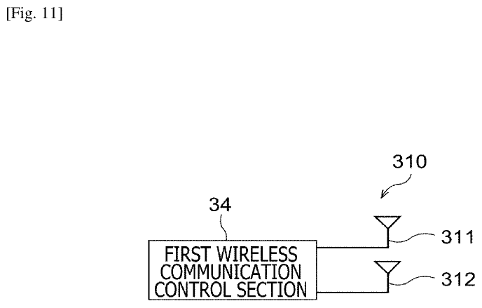

Next, configuration examples of antennas that can be adopted at the drone 10 and the controller 20 are explained by using FIG. 11 to FIG. 13.

An antenna 310 depicted in FIG. 11 includes a first antenna element 311 and a second antenna element 312. Then, the antenna 310 is configured to transmit and/or receive radio waves by using either the first antenna element 311 or the second antenna element 312. The directionality of the first antenna element 311 and the directionality of the second antenna element 312 are mutually different. For example, the transmission directionality and/or the reception directionality of the first antenna element 311 may be made different from the transmission directionality and/or the reception directionality of the second antenna element 312 by making the inclination of the first antenna element 311 and the inclination of the second antenna element 312 mutually different.

In FIG. 11, the first antenna element 311 and the second antenna element 312 are connected to the first wireless communication section 34 in the drone 10. That is, the mobile-body-side antenna A 35 is configured by using the antenna 310. In this case, the antenna control section 38 may change the transmission directionality and/or the reception directionality of the mobile-body-side antenna A 35 by transmitting and/or receiving radio waves after switching from the first antenna element 311 to the second antenna element 312, for example. Note that it is needless to say that the antenna 310 may be adopted as the controller-side antenna A 55 in the controller 20.

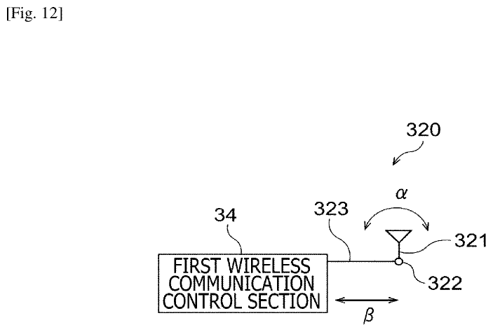

An antenna 320 depicted in FIG. 12 includes an antenna element 321, a support section 322 that rotatably supports the antenna element 321, and an arm 323 that moves the support section 322 back and forth. The inclination of the antenna element 321 can be changed by causing an actuator which is not depicted to rotate the antenna element 321 in the direction of an arrow α about a support point on the support section 322. In addition, the position of the antenna element 321 can be changed by moving the arm 323 back and forth in the direction of an arrow β.

In FIG. 12, the antenna element 321 is connected to the first wireless communication section 34 in the drone 10. That is, the mobile-body-side antenna A 35 is configured by using the antenna 320. In this case, the antenna control section 38 may change the transmission directionality and/or the reception directionality of the mobile-body-side antenna A 35 by changing the inclination and/or the position of the mobile-body-side antenna A 35. Note that it is needless to say that the antenna 320 may be adopted as the controller-side antenna A 55 in the controller 20.

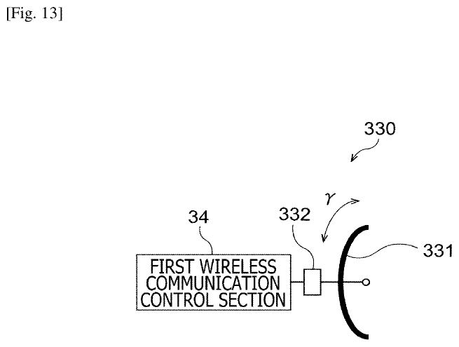

An antenna 330 depicted in FIG. 13 includes a reflection mirror 331 and a transceiver 332. The orientation of the reflection mirror 331 can be changed in the direction of an arrow γ.

In FIG. 13, the antenna 330 is connected to the first wireless communication section 34. That is, the mobile-body-side antenna A 35 is configured by using the antenna 330. In this case, the antenna control section 38 may change the transmission directionality and/or the reception directionality of the mobile-body-side antenna A 35 by changing the orientation of the reflection mirror 331. Note that it is needless to say that the antenna 330 may be adopted as the controller-side antenna A 55 in the controller 20.

### <<Hardware Configuration>>

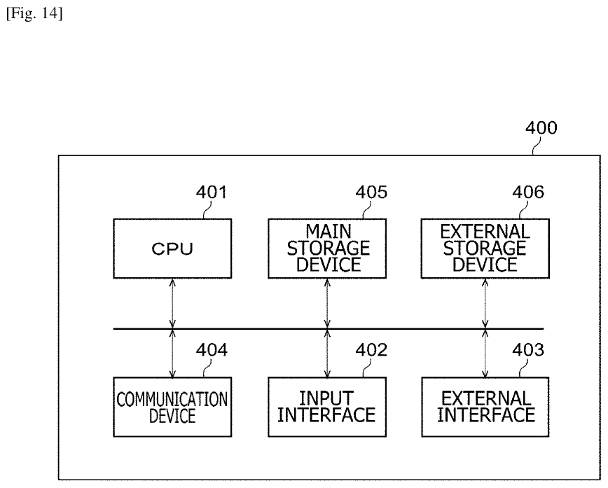

FIG. 14 depicts an example of the hardware configuration of the drone 10 and the controller 20. Each of the drone 10 and the controller 20 is configured by using a computer apparatus 400. The computer apparatus 400 includes a CPU 401, an input interface 402, an external interface 403, a communication device 404, a main storage device 405, and an external storage device 406, and these are interconnected by a bus. The drone 10 and the controller 20 may not include at least one of these elements.

The CPU (central processing unit) 401 executes a computer program on the main storage device 405. The computer program is a program that realizes each type of functional configuration mentioned above of the drone 10. The computer program may be realized not by one program, but by a combination of a plurality of programs or scripts. By the CPU 401 executing the computer program, each type of functional configuration is realized.

The input interface 402 is a circuit for inputting operation signals from an input device such as a keyboard, a mouse, or a touch panel to the drone 10 or the controller 20.

The external interface 403 causes a display apparatus to display data stored on the drone 10 or the controller 20 or data computed by the drone 10 or the controller 20, for example. The external interface 403 may be connected to an LCD (liquid crystal display), an organic electroluminescent display, a CRT (cathode ray tube), or a PDP (plasma display), for example.

The communication device 404 is a circuit for the drone 10 or the controller 20 to communicate with an external device wirelessly or through a cable. Data to be used at the drone 10 or the controller 20 can be input from the external device via the communication device 404. The communication device 404 may include antennas. The data input from the external device can be stored on the main storage device 405 or the external storage device 406. The communication device 404 may acquire specific information (remote ID information) and the like mentioned above from a second drone as an external device directly through the antennas, for example. In addition, the communication device 404 may be connected to a second communication device such as a smartphone or a tablet by a cable or wirelessly. Then, the communication device 404 may acquire, from the second communication device, specific information (remote ID information) and the like of a second drone acquired by the second communication device. In addition, the communication device 404 may be connected to a second communication device such as a smartphone or a tablet by a cable or wirelessly, acquire positional information regarding the second communication device, and identify the position of the communication device 404 and the computer apparatus 400 (i.e. the position of itself) on the basis of the acquired positional information. Such configuration is beneficial in a case where the controller 20 does not include means for identifying the position of itself.

The main storage device 405 stores thereon a computer program, data necessary for execution of the computer program, data generated by execution of the computer program, and the like. The computer program is loaded onto the main storage device 405 and executed thereon. The main storage device 405 is a RAM, a DRAM or a SRAM, for example, but is not limited to these. A storage section for information or data at the communication device 404 may be built on the main storage device 405.

The external storage device 406 stores thereon a computer program, data necessary for execution of the computer program, data generated by execution of the computer program, and the like. These computer program and data are read out by the main storage device 405 when the computer program is to be executed. For example, the external storage device 406 is a hard disk, an optical disc, a flash memory, or a magnetic tape, but is not limited to these.

Note that the computer program may be installed in advance on the computer apparatus 400, or may be stored on a storage medium such as a CD-ROM. In addition, the computer program may be one that has been uploaded onto the Internet.

In addition, the computer apparatus 400 may be configured by using a single apparatus, or may be configured as a system including a plurality of interconnected computer apparatuses.

Note that the embodiments mentioned above depict examples for embodiment of the present disclosure, and the present disclosure can be implemented in various other modes. For example, within the scope not departing from the gist of the present disclosure, various forms of modification, replacement and omission or a combination of these are possible. A mode attained by adopting such modification, replacement, omission or the like also is included in the scope of the present disclosure, and similarly is included in the scope of the disclosure described in claims and the equivalent thereof.

For example, examples of drones which are unmanned aerial vehicles are explained as examples of mobile bodies in the embodiments mentioned above. It should be noted that the technology of the present disclosure can be applied also to underwater drones and the like.

In addition, the technology of the present disclosure is applied to the drone 10 and the controller 20 in the embodiments mentioned above. It should be noted that the technology of the present disclosure can be applied also to the drone 10 and a router, and to the drone 10 and a base station, for example. In this case, the router and the base station correspond to the communication device.

In addition, advantages of the present disclosure described in the present specification are merely illustrated as examples, and there may be other advantages.

Note that the present disclosure can also adopt configuration like the ones below.

### (Item 1)

An information processing method including:
a position identification step of identifying a position of a mobile body and/or a position of a communication device that wirelessly communicates with the mobile body;
a second-machine information reception step of receiving specific information that is sent from a second mobile body, and is for identifying a presence and/or a position of the second mobile body;
a positional relation identification step of identifying a positional relation between the mobile body and the second mobile body and/or a positional relation between the communication device and the second mobile body, on the basis of the position of the mobile body and/or the position of the communication device, and the specific information; and
an antenna control step of controlling at least a directionality of a mobile-body-side antenna of the mobile body and/or a directionality of a communication-device-side antenna of the communication device, on the basis of the positional relation between the mobile body and the second mobile body and/or the positional relation between the communication device and the second mobile body.

### (Item 2)

The information processing method according to item 1, in which, at the antenna control step, transmission power and/or a used frequency are/is changed in addition to the directionality of the mobile-body-side antenna and/or a directionality of the communication-device-side antenna.

### (Item 3)

The information processing method according to item 1 or 2, in which
the mobile-body-side antenna and/or the communication-device-side antenna includes an array antenna including a plurality of antenna elements, and,
at the antenna control step, a reception directionality as the directionality is changed by controlling at least one of a phase and amplitude of radio waves received by the plurality of antenna elements.

### (Item 4)

The information processing method according to any one of items 1 to 3, in which
the mobile-body-side antenna and/or the communication-device-side antenna includes an array antenna including a plurality of antenna elements, and,
at the antenna control step, a transmission directionality as the directionality is changed by controlling at least one of a phase and amplitude of radio waves transmitted by the plurality of antenna elements.

### (Item 5)

The information processing method according to item 1 or 2, in which
the mobile-body-side antenna and/or the communication-device-side antenna includes a plurality of antenna elements, and is configured to receive radio waves by an antenna in the plurality of antenna elements, and
at the antenna control step, a reception directionality as the directionality is changed by receiving radio waves by using another antenna element switched from the any one of the plurality of antenna elements.

### (Item 6)

The information processing method according to any one of items 1 to 5, in which, at the antenna control step, the directionality is changed by changing a position and/or an inclination of the mobile-body-side antenna and/or the communication-device-side antenna.

### (Item 7)

The information processing method according to item 1, in which
the mobile-body-side antenna and/or the communication-device-side antenna includes a reflection mirror, and,
at the antenna control step, the directionality is changed by changing an orientation of the reflection mirror.

### (Item 8)

The information processing method according to any one of items 1 to 7, in which, at the antenna control step, the used frequency is changed in a case where a wireless communication status does not satisfy a predetermined condition after the directionality is changed.

### (Item 9)

The information processing method according to any one of items 1 to 8, in which the mobile body receives the specific information at the second-machine information reception step.

### (Item 10)

The information processing method according to any one of items 1 to 8, in which the communication device receives the specific information at the second-machine information reception step.

### (Item 11)

The information processing method according to item 10, further including:
a step of identifying the position of the second mobile body at the communication device on the basis of the specific information after the second-machine information reception step, in which
information regarding the position of the second mobile body is transmitted from the communication device to the mobile body, and
the positional relation identification step is performed at the mobile body, and the positional relation between the mobile body and the second mobile body is identified by the mobile body on the basis of the position of the mobile body and the position of the second mobile body identified by the specific information.

### (Item 12)

The information processing method according to item 10, in which the positional relation identification step is performed at the communication device after the second-machine information reception step, and thereafter the positional relation between the mobile body and the second mobile body identified at the positional relation identification step is transmitted to the mobile body.

### (Item 13)

The information processing method according to any one of items 1 to 12, in which the specific information includes at least a machine-body registration number of the second mobile body and positional information regarding the second mobile body.

### (Item 14)

The information processing method according to any one of items 1 to 13, in which the specific information includes information that is obligated to send when a mobile body is moved under an obligation imposed by a government or a local government.

### (Item 15)

The information processing method according to item 14, in which the specific information includes information specified under a remote ID system under an obligation imposed by a government regarding flight of unmanned aerial vehicles.

### (Item 16)

The information processing method according to any one of items 1 to 15, in which the mobile body includes an unmanned aerial vehicle.

### (Item 17)

A mobile body including:
a wireless communication section that transmits and receives radio waves via an antenna; and
an antenna control section that controls at least a directionality of the antenna on the basis of a positional relation between the mobile body and a second mobile body.

### (Item 18)

A communication device that wirelessly communicates with a mobile body, including:
a wireless communication section that transmits and receives radio waves via an antenna;
a position identifying section that identifies a position of a mobile body and/or a position of the communication device;
a second-machine information receiving section that receives specific information that is sent from a second mobile body, and is for identifying a presence and/or a position of the second mobile body;
a positional relation identifying section that identifies a positional relation between the mobile body and the second mobile body and/or a positional relation between the communication device and the second mobile body, on the basis of the position of the mobile body and/or the position of the communication device, and the specific information; and
an antenna control section that controls at least a directionality of the antenna on the basis of the positional relation between the mobile body and the second mobile body and/or the positional relation between the communication device and the second mobile body.

### (Item 19)

A computer program that causes a computer to execute:
a position identification step of identifying a position of a mobile body and/or a position of a communication device that wirelessly communicates with the mobile body;
a second-machine information reception step of receiving specific information that is sent from a second mobile body, and is for identifying a presence and/or a position of the second mobile body;
a positional relation identification step of identifying a positional relation between the mobile body and the second mobile body and/or a positional relation between the communication device and the second mobile body, on the basis of the position of the mobile body and/or the position of the communication device, and the specific information; and
an antenna control step of controlling at least a directionality of a mobile-body-side antenna of the mobile body and/or a directionality of a communication-device-side antenna of the communication device on the basis of the positional relation between the mobile body and the second mobile body and/or the positional relation between the communication device and the second mobile body.

### REFERENCE SIGNS LIST

10: Drone (mobile body)
11: Body
12: Front camera
13: Motor
14: Propeller
20: Controller (communication device)
31: Sensor module
32: Calculating section
32A: Positional relation identifying section
33: Flight control section
34: First wireless communication section
35: Mobile-body-side antenna A
36: Second wireless communication section
37: Mobile-body-side antenna B
38: Antenna control section
39: Propulsion apparatus
40: Storage section
41: Rechargeable battery
50: Operation section
51: Controller-position identifying section
52: Calculating section
52A: Positional relation identifying section
54: First wireless communication section
55: Controller-side antenna A
56: Second wireless communication section
57: Controller-side antenna B
58: Antenna control section
59: External device communication section
60: Storage section
61: Rechargeable battery
101: Second-machine drone (second mobile body)
110: Aerial vehicle monitoring facility
112: Antenna
301: Antenna element
302: Phase adjuster
303: Amplitude adjuster
310, 320, 330: Antenna
311: First antenna element
312: Second antenna element
321: Antenna element
322: Support section
323: Arm
331: Reflection mirror
332: Transceiver
400: Computer apparatus
401: CPU
402: Input interface
403: External interface
404: Communication device
405: Main storage device
406: External storage device

1. An information processing method comprising:
a position identification step of identifying a position of a mobile body and/or a position of a communication device that wirelessly communicates with the mobile body;
a second-machine information reception step of receiving specific information that is sent from a second mobile body, and is for identifying a presence and/or a position of the second mobile body;
a positional relation identification step of identifying a positional relation between the mobile body and the second mobile body and/or a positional relation between the communication device and the second mobile body, on a basis of the position of the mobile body and/or the position of the communication device, and the specific information; and
an antenna control step of controlling at least a directionality of a mobile-body-side antenna of the mobile body and/or a directionality of a communication-device-side antenna of the communication device, on a basis of the positional relation between the mobile body and the second mobile body and/or the positional relation between the communication device and the second mobile body.

2. The information processing method according to claim 1, wherein, at the antenna control step, transmission power and/or a used frequency are/is changed in addition to the directionality of the mobile-body-side antenna and/or the communication-device-side antenna.

3. The information processing method according to claim 1, wherein
the mobile-body-side antenna and/or the communication-device-side antenna includes an array antenna including a plurality of antenna elements, and,
at the antenna control step, a reception directionality as the directionality is changed by controlling at least one of a phase and amplitude of radio waves received by the plurality of antenna elements.

4. The information processing method according to claim 1, wherein
the mobile-body-side antenna and/or the communication-device-side antenna includes an array antenna including a plurality of antenna elements, and,
at the antenna control step, a transmission directionality as the directionality is changed by controlling at least one of a phase and amplitude of radio waves transmitted by the plurality of antenna elements.

5. The information processing method according to claim 1, wherein
the mobile-body-side antenna and/or the communication-device-side antenna includes a plurality of antenna elements, and is configured to receive radio waves by an antenna in the plurality of antenna elements, and
at the antenna control step, a reception directionality as the directionality is changed by receiving radio waves by using another antenna element switched from the any one of the plurality of antenna elements.

6. The information processing method according to claim 1, wherein, at the antenna control step, the directionality is changed by changing a position and/or an inclination of the mobile-body-side antenna and/or the communication-device-side antenna.

7. The information processing method according to claim 1, wherein
the mobile-body-side antenna and/or the communication-device-side antenna includes a reflection mirror, and,
at the antenna control step, the directionality is changed by changing an orientation of the reflection mirror.

8. The information processing method according to claim 2, wherein, at the antenna control step, the used frequency is changed in a case where a wireless communication status does not satisfy a predetermined condition after the directionality is changed.

9. The information processing method according to claim 1, wherein the mobile body receives the specific information at the second-machine information reception step.

10. The information processing method according to claim 1, wherein the communication device receives the specific information at the second-machine information reception step.

11. The information processing method according to claim 10, further comprising:
identifying the position of the second mobile body at the communication device on a basis of the specific information after the second-machine information reception step, wherein
information regarding the position of the second mobile body is transmitted from the communication device to the mobile body, and
the positional relation identification step is performed at the mobile body, and the positional relation between the mobile body and the second mobile body is identified by the mobile body on a basis of the position of the mobile body and the position of the second mobile body identified by the specific information.

12. The information processing method according to claim 10, wherein the positional relation identification step is performed at the communication device after the second-machine information reception step, and thereafter the positional relation between the mobile body and the second mobile body identified at the positional relation identification step is transmitted to the mobile body.

13. The information processing method according to claim 1, wherein the specific information includes at least a machine-body registration number of the second mobile body and positional information regarding the second mobile body.

14. The information processing method according to claim 1, wherein the specific information includes information that is obligated to send when a mobile body is moved under an obligation imposed by a government or a local government.

15. The information processing method according to claim 14, wherein the specific information includes information specified under a remote ID system under an obligation imposed by a government regarding flight of unmanned aerial vehicles.

16. The information processing method according to claim 1, wherein the mobile body includes an unmanned aerial vehicle.

17. A mobile body comprising:
a wireless communication section that transmits and receives radio waves via an antenna; and
an antenna control section that controls at least a directionality of the antenna on a basis of a positional relation between the mobile body and a second mobile body.

18. A communication device that wirelessly communicates with a mobile body, comprising:
a wireless communication section that transmits and receives radio waves via an antenna;
a position identifying section that identifies a position of a mobile body and/or a position of the communication device;
a second-machine information receiving section that receives specific information that is sent from a second mobile body, and is for identifying a presence and/or a position of the second mobile body;
a positional relation identifying section that identifies a positional relation between the mobile body and the second mobile body and/or a positional relation between the communication device and the second mobile body, on a basis of the position of the mobile body and/or the position of the communication device, and the specific information; and
an antenna control section that controls at least a directionality of the antenna on a basis of the positional relation between the mobile body and the second mobile body and/or the positional relation between the communication device and the second mobile body.

19. A computer program that causes a computer to execute:
a position identification step of identifying a position of a mobile body and/or a position of a communication device that wirelessly communicates with the mobile body;
a second-machine information reception step of receiving specific information that is sent from a second mobile body, and is for identifying a presence and/or a position of the second mobile body;
a positional relation identification step of identifying a positional relation between the mobile body and the second mobile body and/or a positional relation between the communication device and the second mobile body, on a basis of the position of the mobile body and/or the position of the communication device, and the specific information; and
an antenna control step of controlling at least a directionality of a mobile-body-side antenna of the mobile body and/or a communication-device-side antenna of the communication device on a basis of the positional relation between the mobile body and the second mobile body and/or the positional relation between the communication device and the second mobile body.
